(19) United States
(12) Patent Application Publication
(10) Pub. No.: US 2008/0302976 A1
(43) Pub. Date: Dec. 11, 2008

(54) Sensor with Improved Signal-to Noise Ratio and Improved Accuracy

(75) Inventors: Maarten Marinus Johannes Wilhelmus Van Herpen, Eindhoven (NL); Marcello Leonardo Mario Balistreri, Best (NL); Derk Jan Wilfred Klunder, Eindhoven (NL); Coen Theodorus Hubertus Fransiscus Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/096,183

(22) PCT Filed: Nov. 28, 2006
(86) PCT No.: PCT/IB2006/054476

§ 371 Date: Jun. 5, 2008

(30) Foreign Application Priority Data
Dec. 5, 2005 (EP) 05111674.7

(51) Int. Cl. G01T 1/10

(52) U.S. Cl. 250/459.1; 250/458.1

(57) ABSTRACT

The present invention provides a sensor and a method for detecting an optically variable molecule (9) in a sample (3). The sensor comprises an excitation radiation source (1) for irradiating the sample (4) and exciting the optically variable molecule (9), thus generating a luminescence signal (7). The sensor furthermore comprises a modulation means (4) for modulating the excitation radiation beam (2) in a direction different from, preferably substantially perpendicular to, a scanning direction of the excitation radiation beam (2) over the sample (3). The method and sensor according to the invention lead to an improved signal-to-noise ratio by reducing and even minimising the background signal in the luminescence signal (7) and to an improved accuracy by minimising signals coming from false-positives.

The present invention relates to luminescence sensors, such as luminescence biosensors or luminescence chemical sensors, comprising modulation means for modulating an excitation beam with which the sensor is illuminated. The invention furthermore relates to a method for the detection of analyte molecules by means of optically variable molecules, for example by means of luminophores, e.g. fluorophores, in a sample which always luminesce or which only luminesce when attached to a substrate, or by means of luminophores attached to a substrate which luminesce when an analyte molecule binds to them, this detection being by using the sensor according to the present invention.

Sensors are widely used for measuring a physical attribute or a physical event. They output a functional reading of that measurement as an electrical, optical or digital signal. That signal is data that can be transformed by other devices into information. A particular example of a sensor is a biosensor. Biosensors are devices that detect the presence of (i.e. qualitative) or measure a certain amount (i.e. quantitative) of target molecules such as e.g., but not limited thereto, proteins, viruses, bacteria, cell components, cell membranes, spores, DNA, RNA, etc. in a fluid, such as for example blood, serum, plasma, saliva, . . . . The target molecules are also called the “analyte”. In almost all cases, a biosensor uses a surface that comprises specific recognition elements for capturing the analyte. Therefore, the surface of the sensor device may be modified by attaching specific molecules to it, which are suitable to bind the target molecules which are present in the fluid.

For optimal binding efficiency of the analyte to the specific molecules, large surface areas and short diffusion lengths are highly favourable. Therefore, micro- or nano-porous substrates (membranes) have been proposed as biosensor substrates that combine a large area with rapid binding kinetics. Especially when the analyte concentration is low (e.g. below 1 nM, or below 1 pM) the diffusion kinetics play an important role in the total performance of a biosensor assay.

The amount of bound analyte may be detected by luminescence, e.g. fluorescence. In this case the analyte itself may carry a luminescent, e.g. fluorescent, label, or alternatively an additional incubation with a luminescently labelled, e.g. fluorescently labelled second recognition element may be performed.

Detecting the amount of bound analyte can be hampered by several factors, such as scattering of light, bleaching of the luminophore, background luminescence of the substrate and incomplete removal of excitation light. Moreover, to be able to distinguish between bound labels and labels in solution it is necessary to perform one or more washing steps to remove unbound labels.

However, when trying to detect luminescence, e.g. fluorescence, of a single bead, the noise in the measured luminescence signal, e.g. fluorescence signal, becomes important. Due to this noise, it is possible that false-positives or false-negatives are given when detecting a luminophore, e.g. fluorophore. A false-positive refers to an event where the measurement falsely indicates the presence of a luminophore, e.g. fluorophore, where it is actually measuring background. A false-negative refers to an event where the measurement overlooks the presence of a luminophore, e.g. fluorophore. The occurrence of these false-positives or false-negatives makes it difficult to detect a single luminophore, e.g. fluorophore, with a noisy signal/background ratio.

Furthermore, when a single luminophore, e.g. fluorophore, has a diameter smaller than the size of the excitation spot, then the background noise in the luminescence signal, e.g. fluorescence signal, depends on the total area that is illuminated with the excitation beam, because the spot not only illuminates the luminophore, e.g. fluorophore, but also illuminates its environment. This environment causes a background signal, which leads to a bad signal-to-noise or signal-to-background ratio because this signal-to-background ratio is limited by the finite size (diffraction limit) of the spot.

It is an object of the present invention to provide a sensor with improved signal-to-background ratio and/or with improved accuracy and a method for the detection of a luminophore in a sample using such a sensor.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

In a first aspect of the invention a method is provided for the detection of an optically variable molecule in or on a sample. The method comprises:

moving the sample relative to an excitation radiation beam in a first direction, hereby exciting the optically variable molecule and thus generating a luminescence signal, and

detecting the generated luminescence signal,

wherein the method furthermore comprises spatially modulating the relative position of the excitation radiation beam with respect to the sample when detecting the luminescence signal, the modulation providing relative movement of the sample with respect to the excitation radiation beam in a second direction different from the first direction.

The relative movements can include moving the excitation radiation beam in a first direction and a second direction relative to the sample, or moving the sample relative to the excitation beam in the two directions, or can also include one of the two movements being movement of the excitation beam relative to the sample and the second of the two movements being moving the sample relative to the excitation radiation beam.

The excitation radiation beam may, for example, be a signal excitation radiation beam.

The optically variable molecules may be any suitable molecule for luminescent analysis, e.g. molecules with which analyte molecules are labelled, and which always luminesce upon being irradiated by an illumination beam. Bound optically variable molecules are visualised, while non-bound optically variable molecules are washed away. Alternatively, the optically variable molecules may be marker molecules with which the analyte molecules are labelled, and which only luminesce when they are bound to molecules attached to a substrate. This makes a donor-acceptor pair. Washing is used to obtain stringency. Lightly bound molecules are washed away. In still another embodiment, molecules attached to a substrate luminesce when an analyte molecule binds to them. Washing is used to obtain stringency. Lightly bound molecules are washed away.

In a preferred embodiment according to the first aspect of the present invention, the second direction may be substantially perpendicular to the first direction.

The method according to the present invention gives a luminescence, e.g. fluorescence signal with an improved signal-to-noise ratio (SNR) and an improved accuracy. An improved SNR is obtained by using a modulation scheme which reduces electronic noise and at least partially removes background signals. One reason why an improved accuracy is obtained is because signals caused by false-positives can be minimised using the method according to the invention. A false-positive refers to an event where the measurement falsely indicates the presence of an optically variable molecule where it is actually measuring background. The occurrence of these false-positives makes it difficult to detect a single optically variable molecule, e.g. fluorophore, with a noisy signal/background ratio. Hence, by minimising the signal coming from false-positives the method according to the invention gives a signal with improved accuracy.

According to embodiments of the invention the method may furthermore comprising demodulating the detected luminescence signal, thus generating a demodulated signal.

According to embodiments of the invention, the sign and/or amplitude of the demodulated signal may be used as an error signal for the position of the optically variable molecule.

The modulation may be performed with a first frequency and a demodulation signal for demodulating the signal may have a second frequency, the first and second frequencies not being the same. According to embodiments of the invention, the second frequency or frequency for demodulating the detected luminescence signal may be twice or any other factor of the modulation frequency. In this case, the method according to the invention may be used to remove the background signal from the detected luminescence signal, as by demodulating the detected signal according to these embodiments, a demodulated signal may be obtained in which the background signal is minimised or even completely removed.

In other embodiments according to the invention, the second frequency, i.e. the frequency for demodulating the detected luminescence signal may be the same as the first or modulation frequency. By using the method according to this other embodiments, optically variable molecules can be located.

In further embodiments according to the invention, the excitation radiation beam has a spot with a size and the method may further comprise:

from the detected luminescence signal determining a relative position of the optically variable molecule with respect to the excitation radiation beam,

centring the excitation radiation beam with respect to the optically variable molecule,

reducing the size of the spot, and

determining a further generated luminescence signal.

To allow centring either the beam can be moved with respect to the sample or the sample can be moved relative to the beam.

In yet other embodiments, the method may furthermore comprise using the further generated luminescence signal for determining whether the generated luminescence signal indicated is a false-positive or not. The occurrence of these false-positives makes it difficult to detect a single optically variable molecule, e.g. fluorophore, with a noisy signal/background ratio. Hence, by minimising the signal coming from false-positives, the accuracy of the method according to the present invention may be improved.

In a second aspect of the invention, a sensor is provided for detecting an optically variable molecule in or on a sample. The sensor comprises:

an excitation radiation source for generating an excitation radiation beam,

scanning means for relative movement of the excitation radiation beam with respect to the sample in a first direction for scanning the sample,

wherein the sensor furthermore comprises modulating means for spatially modulating the relative position of the excitation radiation beam with respect to the sample to provide relative movement of the excitation radiation beam with respect to the sample in a second direction different from the first direction.

The relative movements can include moving the excitation radiation beam in a first direction and a second direction relative to the sample, or moving the sample relative to the excitation beam in the two directions, or can also include one of the two movements being movement of the excitation beam relative to the sample and the second of the two movements being moving the sample relative to the excitation radiation beam.

The excitation radiation beam may, for example, be a signal excitation radiation beam.

In a preferred embodiment according to the first aspect of the present invention, the second direction may be substantially perpendicular to the first direction.

The method according to the present invention gives a luminescence, e.g. fluorescence signal with an improved signal-to-noise ratio (SNR) and/or with an improved accuracy. In one aspect of the present invention an improved SNR is obtained by using a modulation scheme which reduces electronic noise and at least partially removes background signals. One reason why an improved accuracy is obtained is because signals caused by false-positives can be minimised using the method according to the invention. A false-positive refers to an event where the measurement falsely indicates the presence of an optically variable molecule where it is actually measuring background. The occurrence of these false-positives makes it difficult to detect a single optically variable molecule, e.g. fluorophore, with a noisy signal/background ratio. Hence, by minimising the signal coming from false-positives the method according to the invention gives a signal with improved accuracy.

According to embodiments of the invention, the sensor may furthermore comprise a detector for detecting a luminescence signal generated by an optically variable molecule upon irradiation with the excitation radiation beam. The detector may, for example, be a charge coupled device (CCD) detector, a camera or a complementary metal oxide semiconductor (CMOS) detector but also includes an optical sensor or a microscope.

According to embodiments of the invention, the sensor may furthermore comprise demodulating means for demodulating the detected luminescence signal. The demodulating means may, for example, be a lock-in amplifier.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

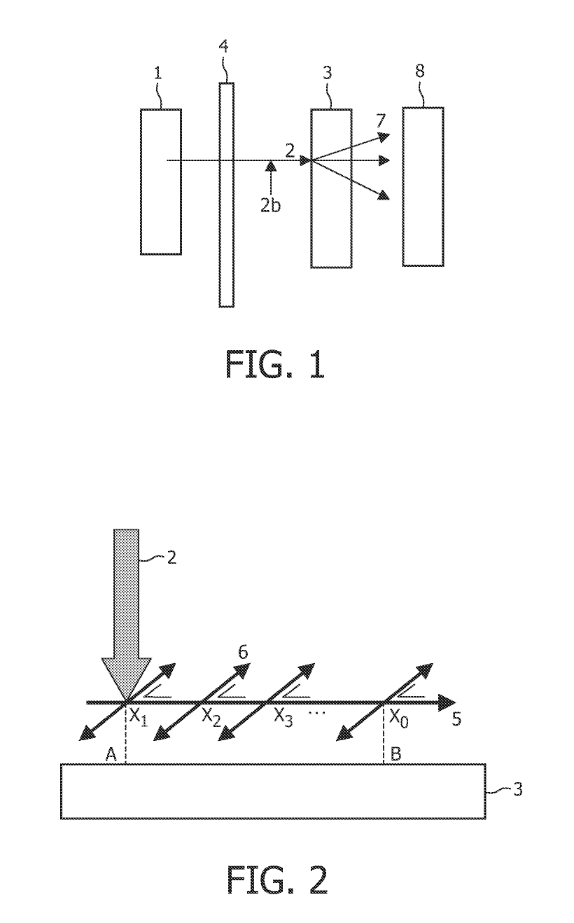

FIG. 1 is a schematic illustration of a sensor according to an embodiment of the present invention.

FIG. 2 illustrates a method according to embodiments of the present invention.

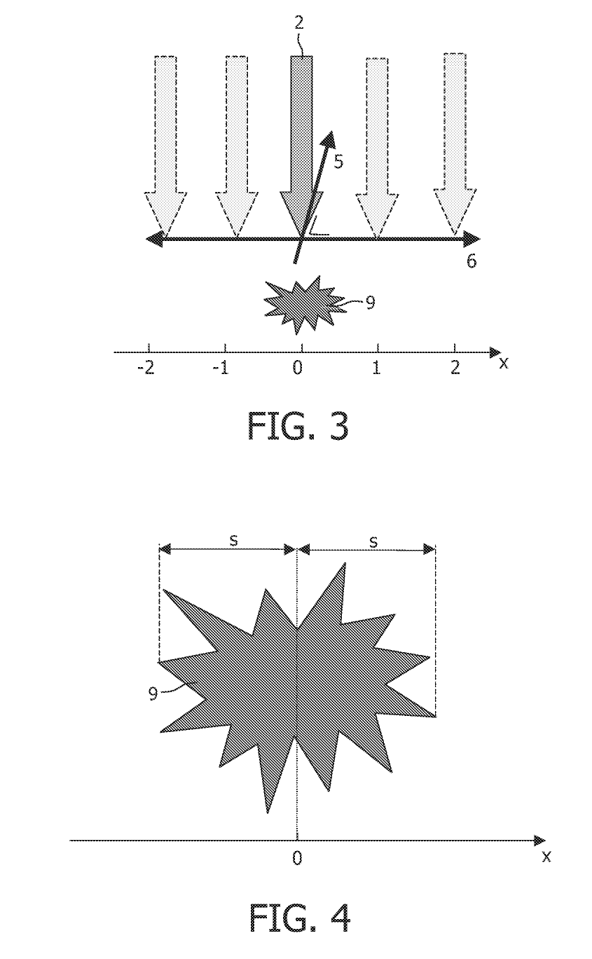

FIG. 3 shows a luminophore which is centred with respect to the modulation of the excitation radiation beam.

FIG. 4 illustrates the size of the luminophore with respect to the position of the excitation radiation beam.

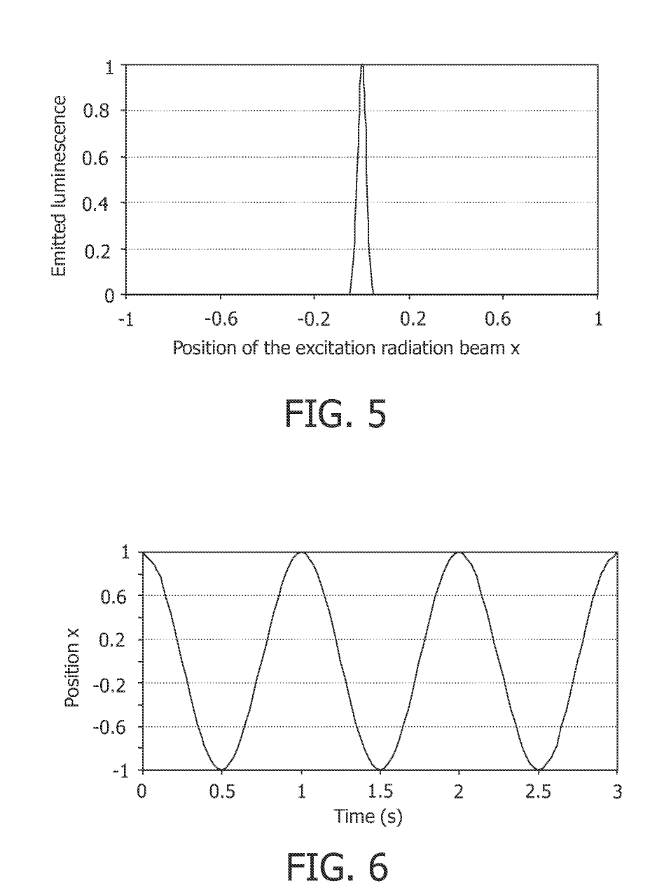

FIG. 5 shows the response of a luminophore as a function of its position with regard to the excitation radiation beam.

FIG. 6 illustrates the time-dependent position of an excitation radiation beam with modulation frequency f=1 and amplitude A=1.

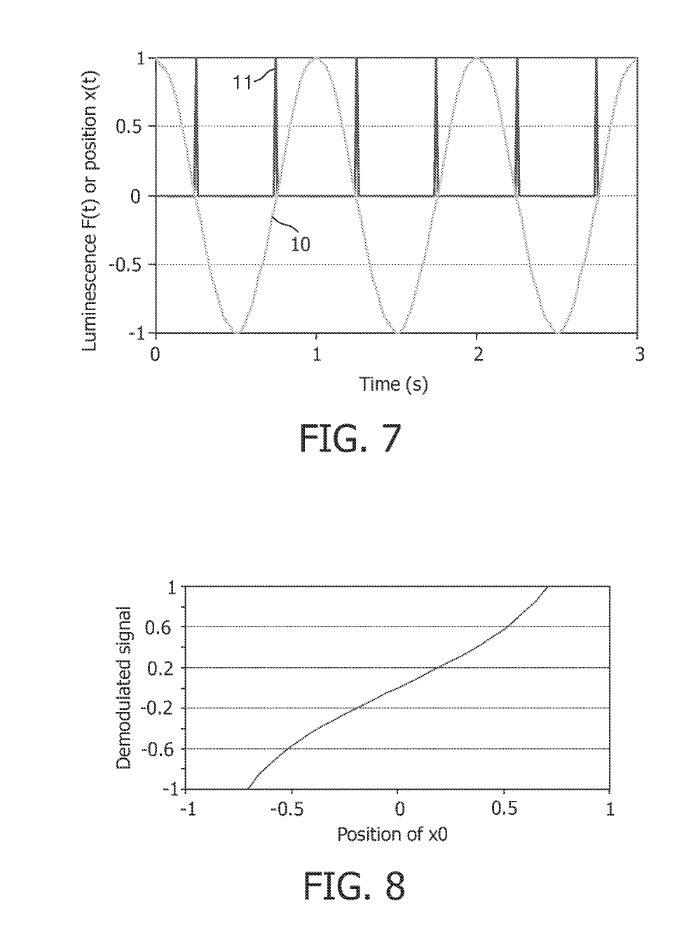

FIG. 7 shows the luminescence response due to a variable position of the excitation spot in time.

FIG. 8 shows the demodulated signal as a function of the position of the excitation radiation beam with respect to a luminophore for a luminophore which is not centred with respect to the excitation radiation beam and for a reference signal that is equal to the frequency of the modulation.

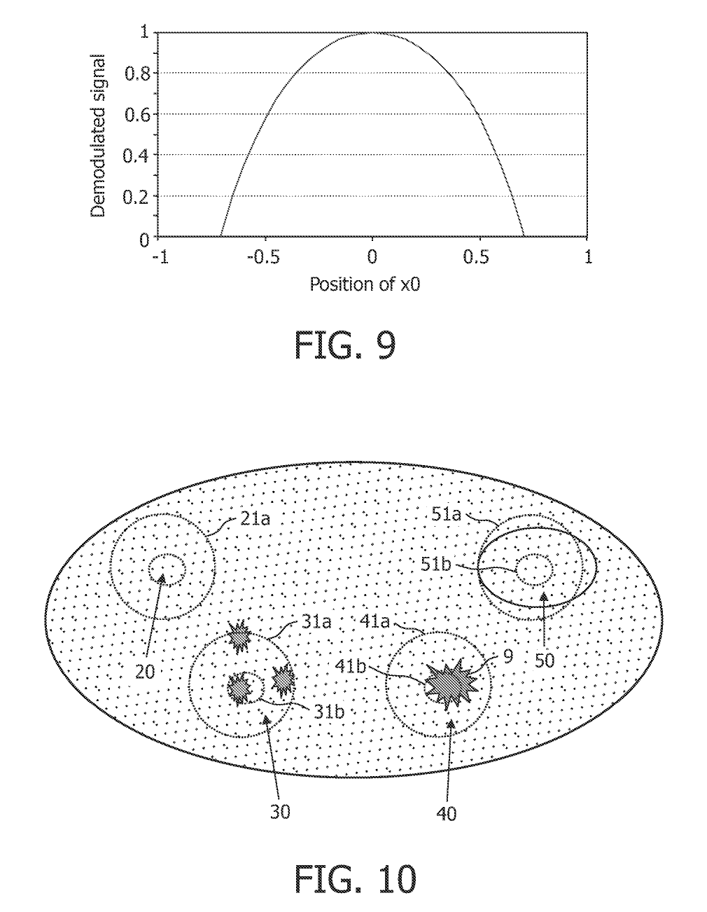

FIG. 9 shows the demodulated signal as a function of the position of the excitation radiation beam with respect to a luminophore for a luminophore which is not centred with respect to the excitation radiation beam and for a reference signal that is twice the frequency of the modulation.

FIG. 10 schematically illustrates how a smaller excitation spot can improve the signal-to-noise ratio.

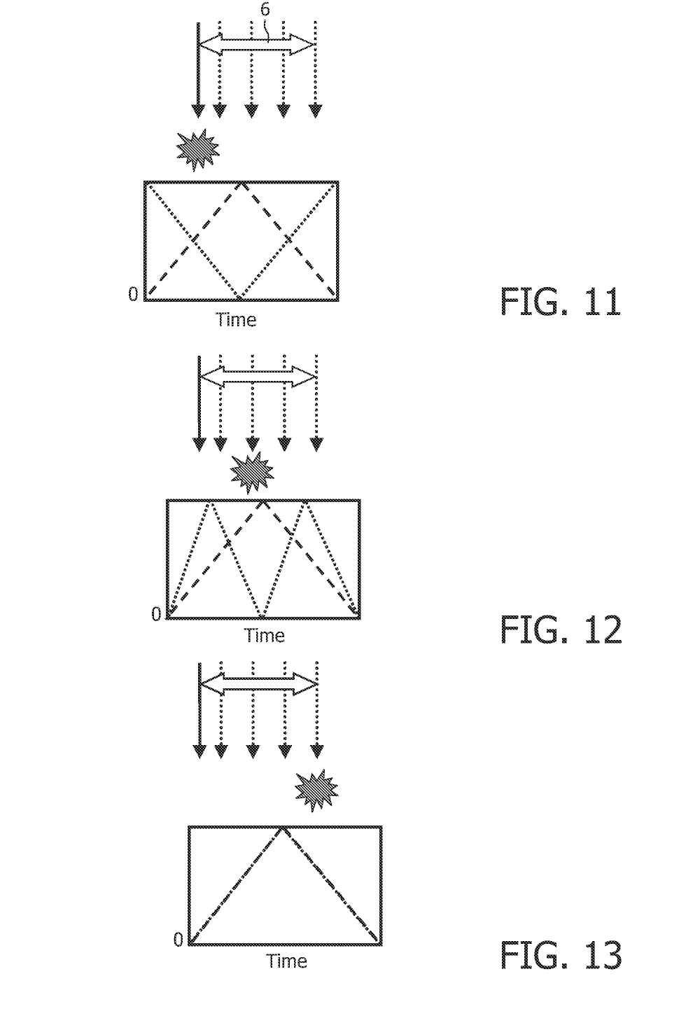

FIG. 11 to FIG. 13 illustrate different positions of a luminophore with respect to an excitation radiation beam and the corresponding reference and luminescence signals.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In one aspect, the present invention provides a method for detecting at least one “optically variable molecule”, e.g. luminophore or luminescent molecule, present in or on a sample or medium. Such molecules can be, for instance, fluorescent, electroluminescent, chemoluminescent molecules, etc. The optically variable molecule may then be used for labelling an analyte present in the medium.

There are at least three possible situations for using optically variable molecules in the labelling of an analyte:

1) analyte molecules are labelled with optically variable molecules which always luminesce, e.g. fluoresce. Those molecules which are bound to capture molecules, e.g. attached to a substrate, can be visualised, all other optically variable molecules can be washed away.
2) Analyte molecules are labelled with marker molecules which only luminesce, e.g. fluoresce, when they are bound to molecules attached to a substrate. In that way a donor acceptor pair is formed. A washing step is in this case used to obtain stringency as lightly bound molecules will be washed away.
3) Molecules attached to a substrate luminesce, e.g. fluoresce, when an analyte molecule binds to them. Washing is again used to obtain stringency as lightly bound molecules are washed away.

The present invention will be described for optically variable molecules, i.e. luminescent labels, being attached to an analyte in the medium, the analyte binding to recognition labels being washed away, the labels luminescing when being irradiated by an illumination beam scanning the sensor and impinging onto them. In the further description, the terms “luminescent molecule” and “luminophore” will be used as synonyms. It has to be understood that this is not limiting the invention and that the invention also applies in the other cases described above.

The method according to the present invention comprises spatially modulating the position of an excitation radiation beam relative to a sample to be measured. According to the present invention, this leads to a detection signal with an improved signal-to-noise ratio. The present invention, in another aspect, provides a luminescence sensor, such as e.g. a luminescence biosensor or a luminescence chemical sensor, with improved signal-to-noise ratio, suitable for carrying out the method according to the invention. Therefore, the sensor according to the present invention comprises a modulating means for spatially modulating the relative position of the excitation radiation beam and a sample according to the method of the invention.

When dealing with single molecule detection, spatial modulation of the relative position of excitation radiation beam and the sample can be used in order to improve the signal-to-noise ratio and/or in order to find the location of a luminophore, e.g. fluorophore. In the latter case, spatial modulation of the relative position of the excitation radiation beam and the sample can be used to localise a luminophore, e.g. fluorophore, and thereafter to centre the excitation radiation beam on the luminophore, e.g. fluorophore (see further).

According to embodiments of the present invention, the position of an excitation radiation beam is spatially modulated with respect to a luminescent molecule, e.g. fluorescent molecule.

Hereinafter, a method for the detection of at least one luminophore, e.g. fluorophore, according to embodiments of the present invention will be described. The method according to the invention yields a detection signal with improved signal-to-noise ratio (SNR) and/or with improved accuracy. According to the invention, the SNR is improved by spatially modulating the excitation radiation beam emanating from an excitation radiation source and used for irradiating the luminophores, e.g. fluorophores, in order to excite them. After excitation, the luminophore, e.g. fluorophore, will emit luminescence radiation, e.g. fluorescence radiation, with a particular intensity A.

In FIG. 1 a schematic illustration of an embodiment of a sensor system according to the invention is shown. In this figure, a possible implementation of a sensor which can be used for carrying out the method according to the invention is shown. An excitation radiation source 1, e.g. a light source, directs an excitation radiation beam 2, e.g. light, onto a sample plate 3 comprising at least one luminescent, e.g. fluorescent, molecule (not shown in FIG. 1). According to embodiments of the present invention, different excitation radiation sources 1 may be used, such as e.g. a multi-spot light source, using for example the Talbot effect for imaging. Alternatively, a focussed light spot, e.g. a focussed laser spot may be used as radiation beam 2. The position of the excitation radiation beam 2 can be varied by moving the position of the excitation radiation source 1 and/or by modulating the position of the excitation radiation beam 2 with respect to a fixed excitation radiation source 1, or by moving the sample plate 3 with respect to the radiation beam 2. For example the sample may be placed on an X-Y table and the X-Y table position may be moved to thereby change the relative position of the sample and the beam. According to an aspect of the present invention, the position of the excitation radiation beam 2 relative to the sample plate 3 is varied by moving the excitation radiation beam relative to the sample plate in a first direction from a first position to a second position (scanning movement), hereby scanning the sample plate 3 and by modulating the position of the excitation radiation beam 2 relative to the sample plate at each position of the first direction in a second direction, the second direction being different from and preferably substantially perpendicular to the first direction. Modulation of the position of the excitation radiation beam 2 is carried out by modulation means 4. Examples of suitable modulation means 4 which may be used according to the invention are an acousto-optic modulator (AOM), a prisma-pair, a multi-mode interferometer (by changing the focal plane of the input beam), a mirror that is moved with a galvano or piezo element, or a liquid crystal.

In FIG. 2, a basic principle of the method according to the present invention is illustrated. Thus, according to an aspect of the present invention, an excitation radiation beam 2 scans a sample plate 3 comprising luminescent molecules, e.g. fluorescent molecules, in a first direction (indicated by reference number 5 in FIG. 2) from a first position A to a second position B. On top of this first movement 5, the excitation radiation beam 2 exerts a second movement in a second direction (indicated by arrows 6 in FIG. 2), the second direction 6 being different from the first direction 5, and being preferably substantially perpendicular to the first direction 5. The second movement (indicated by arrow 6) is a preferably periodic movement carried out on top of the scanning movement and one possibility is an oscillation with a frequency f around locations X₁, X₂, . . . , X₀ at each point in between the first position A and the second position B. The part of the excitation radiation beam 2 after modulation will be referred to as the modulated signal 2b.

Luminescence radiation 7, e.g. fluorescence radiation, which is emitted by the luminescent molecules, e.g. fluorescent molecules, upon irradiation with excitation radiation 2, e.g. excitation light, more particularly by modulated signal 2b, is measured by means of a detector 8. According to embodiments of the invention, the detector 8 may be any suitable detector for detecting luminescence radiation 7, such as e.g. a charge coupled device (CCD) or a camera or complementary metal oxide semiconductor (CMOS) detector, a photodiode or an array of these, a phototransistor or an array of these, a camera or a microscope. Alternatively, a scanning approach may be used for the detector, in which the detector comprises a limited number of detection cells and only a small imaging view is obtained. Luminescence radiation 7, e.g. fluorescence radiation, is then collected on a detector cell, e.g. photodiode for a certain time in such a way that an optimal signal to noise ratio may be obtained. This may substantially increase the sensitivity of the sensor. After detection by the detector 8, the detected signal may be demodulated with a suitable demodulation means such as, for example, a lock-in amplifier.

Hereinabove, a method according to an embodiment of the present invention has been described by means of an implementation of a particular sensor for carrying out the method of the present invention. It has, however, to be understood that other implementations of sensors can also be applied with the present invention. For example, in the above description a sensor has been used in transmission mode. This means that the excitation radiation source 1 is positioned at a first side of the sensor and the detector 8 for detecting luminescence, e.g. fluorescence, radiation 7 is positioned at a second side of the sensor, the first and second side being opposite to each other with regard to the sensor. In other implementations, a sensor may be used in reflection mode, i.e. the excitation radiation source 1 may then be positioned at a same side of the sensor as the detector 6. Whether transmission or reflection mode is used depends on the type of sensor that is used for carrying out the method according to the present invention.

Theoretically, for obtaining a demodulated luminescence signal indicative of the presence (qualitative and/or quantitative) of luminophores on the sample plate 3 and suitable to be used for a particular application (see further), four different possible settings with respect to the position of the excitation radiation beam 2 toward the luminescent molecule 7, e.g. fluorescent molecule, and to the frequency of the modulation may be taken into account. Before specific embodiments according to the present invention will be described, these four theoretical cases will be discussed.

In a first theoretical case, as illustrated in FIG. 3, a luminescent, e.g. fluorescent, molecule 9 is centred with respect to the modulation of the position of the excitation radiation beam 2 in the second direction 6. In this first case, the luminescent, e.g. fluorescent, molecule 9 is thus supposed to be positioned at location x=0, which means at the centre of the modulation movement of the position of the excitation radiation beam 2 (see FIG. 3), and has a size s. The size s is defined as half the size of the cross-section of the luminescence molecule 9, e.g. fluorescence molecule, as illustrated in FIG. 4. The excitation radiation beam 2 emanating from the excitation radiation source 1 is moved or modulated in the modulation direction 6 with a modulation frequency f from position x=−Z to x=+Z, in the example illustrated in FIG. 3 from x=−2 to x=+2. FIG. 5 shows the emitted luminescence radiation 7, e.g. fluorescence radiation, as a function of the position of the modulated excitation radiation beam 2b. In the example given in FIG. 5 the excitation radiation beam 2 emanating from the excitation radiation source 1 is modulated from position x=−1 to x=+1. The response of the luminescent, e.g. fluorescent, molecule 9 to the modulated excitation radiation beam 2b can then be described as:

$$I ( x ) = \{ \begin{matrix}Λ & \vert x \vert \leq s \\ 0 & \vert x \vert > s\end{matrix} \qquad ( 1 )$$

This means that the luminescent molecule 9 will only emit luminescence radiation 7 when the excitation radiation beam 2 is at the position of the luminescent, molecule, or in other words, when the position of the excitation radiation beam 2 is such that the luminescent molecule 9 is at least partly irradiated by this excitation radiation beam 2.

According to the present invention, modulation of the position of the excitation radiation beam 2 is done periodically. Hence, from the above and as already described the movement of the excitation radiation beam 2 is twofold. A first movement is exerted on the excitation radiation beam 2 for scanning a sample comprising luminescent, e.g. fluorescent, molecules 9 from a first position (in the example given A) to a second position (in the example given B) in a first or scanning direction 5. At each position x in between the first and second position, furthermore a second, periodic, movement in a second direction 6 is applied to the excitation radiation beam 2. This periodic movement can be substantially perpendicular to the first direction 5 of the first movement, for example. The second movement is in the further discussion referred to as modulation and has a driving frequency f and an amplitude A.

The position x of the excitation radiation beam 2 can thus be described by a periodic function in time t:

x(t)=A cos(f·2π·t) (2)

For example, with f=1 and A=1, x(t) looks like illustrated in FIG. 6.

In order to determine the luminescence, e.g. fluorescence, radiation 7, indicated by F(t), that is generated by the luminescent, e.g. fluorescent, molecule 9 upon irradiation with the modulated excitation radiation beam 2b at position x, equation (1) and (2) need to be combined, yielding:

$$\begin{matrix}F ( t ) = I ( x ( t ) ) = I ( A cos ( f \cdot 2 π \cdot t ) ) & ( 3 ) \\ F ( t ) = \{ \begin{matrix}Λ & \vert A cos ( f \cdot 2 π \cdot t ) \vert \leq s \\ 0 & \vert A cos ( f \cdot 2 π \cdot t ) \vert > s\end{matrix} & ( 4 )\end{matrix}$$

If the size of the luminescent, e.g. fluorescent, molecule 9 is small compared to the modulation amplitude or modulation depth (s<<A), this equation can be approximated by assuming s=0, giving, when taking into account the assumption that the luminescent molecule 9 is centred with respect to the modulation of the position of the excitation radiation beam 2 in the second direction:

$$\begin{matrix}F ( t ) = \{ \begin{matrix}Λ & \vert A cos ( f \cdot 2 π \cdot t ) \vert \leq 0 \\ 0 & \vert A cos ( f \cdot 2 π \cdot t ) \vert > 0\end{matrix} & ( 5 a ) \\ F ( t ) = \{ \begin{matrix}Λ & f \cdot 2 π \cdot t = \frac{1}{2} π + k \cdot π \\ 0 & f \cdot 2 π \cdot t \neq \frac{1}{2} π + k \cdot π\end{matrix} & ( 5 b ) \\ F ( t ) = \{ \begin{matrix}Λ & t = \frac{1}{4 f} + k \frac{1}{2 f} \\ 0 & t \neq \frac{1}{4 f} + k \frac{1}{2 f}\end{matrix} & ( 5 c )\end{matrix}$$

When displayed in a graph, with Λ=1, equation (6) is as illustrated in FIG. 7, which shows the luminescence, e.g. fluorescence, response due to a variable position of the excitation radiation beam 2 in time (indicated by reference number 10 in FIG. 7). From this figure it can be seen that, in time, the luminescent, e.g. fluorescent, radiation 7 is represented by periodic peaks (indicated by reference number 11). These periodic peaks correspond to every time the excitation radiation beam 2 passes over the luminescent molecule 9 present on the sample plate 3.

The demodulated signal S can then be determined by multiplying the measured luminescence, e.g. fluorescence, signal F(t) with a reference signal R(t) followed by the integration of the result over a certain time. In order to show the effect of a constant background signal, an extra term B(t) is added, which describes the constant background signal as B(t)=b:

$$S = {\int }_{t = 0}^{t = t 1} ( F ( t ) + B ( t ) ) R ( t ) d t \qquad ( 7 )$$

The reference signal R(t) has an amplitude D and according to this first case it is supposed that the frequency of the reference signal R(t) is twice the driving frequency f of the position of the excitation radiation beam 2 at a certain time t. The frequency of the reference signal R(t) then equals 2f and R(t) can be written as:

R(t)=D cos(2f·2π·t+Φ)=D cos(f·4π·t+Φ) (8)

wherein Φ is a phase term.

Inserting equation (8) into equation (7) yields:

$$S = {\int }_{t = 0}^{t = t 1} ( F ( t ) + B ( t ) ) D cos ( f \cdot 4 π \cdot t + φ ) d t \qquad ( 9 )$$

or for a constant background signal:

$$S = {\int }_{t = 0}^{t = t 1} ( F ( t ) + b ) D cos ( f \cdot 4 π \cdot t + φ ) d t \qquad ( 10 )$$

This integral can be split up in two parts:

$$S = \underbrace{{\int }_{t = 0}^{t = t 1} F ( t ) D cos ( f \cdot 4 π \cdot t + φ ) d t}_{1} + \underbrace{{\int }_{t = 0}^{t = t 1} b \cdot D cos ( f \cdot 4 π \cdot t + φ ) d t}_{2} \qquad ( 11 )$$

Part 1 of equation (11) describes the luminescence, e.g. fluorescence, radiation 7 due to the luminescent, e.g. fluorescent, molecule 9 upon irradiation with the modulated excitation radiation beam 2b and part 2 describes the luminescence, e.g. fluorescence, radiation due to the background.

It can be seen that the impact of the background signal on the demodulated signal S is 0, because when time t1 is long enough part 2 of equation (11) equals zero. The demodulated signal then equals:

$$\begin{matrix}S = {\int }_{t = 0}^{t = t 1} F ( t ) D cos ( f \cdot 4 π \cdot t + φ ) d t \\ with & ( 12 ) \\ F ( t ) = \{ \begin{matrix}Λ & \vert A cos ( f \cdot 2 π \cdot t ) \vert \leq 2 \\ 0 & \vert A cos ( f \cdot 2 π \cdot t ) \vert > s\end{matrix} & ( 13 )\end{matrix}$$

From the above discussion it can be concluded that a modulated excitation radiation beam 2b according to the invention can be used to remove the background signal from the luminescence, e.g. fluorescence, signal 7.

Hereinafter, the value of the demodulated luminescence, e.g. fluorescence, signal S will be determined. It is possible to rewrite the integral into a sum. In principle, this is done by counting the impact of the various peaks in F(t) (see FIG. 7), which depends on the exposure time τ of the luminescent, e.g. fluorescent, molecule 9 when the excitation radiation beam 2 passes. This time depends on the speed of the excitation radiation beam 2, which is given by:

v(t)=x′(t)=−Af·2πsin(f·2π·t) (14)

If the size of the luminescent, e.g. fluorescent, molecule 9 is small compared to the modulation amplitude or modulation depth (s<<A), the exposure time τ of the luminescent, e.g. fluorescent, molecule 9 to the excitation radiation beam 2 can be approximated by:

$$τ = \vert \frac{s}{v ( t )} \vert = \vert \frac{s}{Af \cdot 2 π sin ( f \cdot 2 π \cdot t )} \vert \qquad ( 15 )$$

The integral of equation (12) then becomes:

$$S = {\sum }_{A cos ( f \cdot 2 π \cdot t ) = 0} Λ \cdot D cos ( f \cdot 4 π \cdot t + φ ) \cdot \vert \frac{s}{Af \cdot 2 π sin ( f \cdot 2 π \cdot t )} \vert \qquad ( 16 )$$

wherein the sum goes over the values of t where:

$$\begin{matrix}A cos ( f \cdot 2 π \cdot t ) = 0 & ( 17 a ) \\ f \cdot 2 π \cdot t = \frac{1}{2} π + k π & ( 17 b ) \\ t = \frac{1}{4 f} + \frac{k}{2 f} & ( 17 c )\end{matrix}$$

This gives:

$$\begin{matrix}S = {\sum }_{k = 0 , 1 , 2 …} Λ \cdot D cos ( π + k \cdot 2 π + φ ) \cdot \vert \frac{s}{Af \cdot 2 π sin ( \frac{1}{2} π + k π )} \vert & ( 18 ) \\ S = {\sum }_{k = 0 , 1 , 2 …} \frac{Λ \cdot sD}{Af \cdot 2 π} cos ( π + φ ) & ( 19 )\end{matrix}$$

The maximum value of k depends on the number of periods in the oscillation. The number of periods is given by the frequency f of the modulation and the total integration time t₀:

$$\begin{matrix}{t}_{0} = \frac{1}{4 f} + \frac{{k}_{max}}{f} & ( 20 a ) \\ {k}_{max} = {t}_{0} f - \frac{1}{4} & ( 20 b )\end{matrix}$$

Equation (19) then becomes:

$$S = ( {t}_{0} f - \frac{1}{4} ) \frac{Λ \cdot sD}{Af \cdot 2 π} cos ( π + φ ) \qquad ( 21 )$$

The result in equation (21) means that the demodulated signal S will have a constant value, depending on the phase Φ of the reference signal R(t).

From the above, it can be concluded that, if the location of the luminescent molecule 9 is centred with respect to the modulation of the position of the excitation radiation beam 2, the demodulated signal S will be independent of the constant background signal and will be directly proportional to the luminescence signal 7, when using a reference signal for demodulation which has a frequency of twice the modulation frequency f.

Hence, the above-described settings of the position of the excitation radiation beam 2 with respect to the luminescent, e.g. fluorescent, molecules 9 and of the frequency of the reference signal R(t) for demodulation, i.e. the excitation radiation beam 2a emanating from the excitation radiation source 1, with respect to the frequency of the modulation, a luminescence, e.g. fluorescence, radiation signal can be obtained which, after demodulation, shows no or substantially no background signal and thus has an improved signal-to-noise ratio with respect to prior art sensors.

Next, a second theoretical case will be described in order to indicate that, when the same situation occurs as in the first case, but when now a reference signal is used with a same frequency as the modulation frequency f, no useful results can be obtained. Hence, in this second case, a luminescent, e.g. fluorescence, molecule 9 is positioned at the centre of the modulation of the excitation radiation beam 2 and the frequency of the reference signal R(t) for demodulation is the same as the frequency f of the modulation. Using similar calculations as in the first case, it can be shown that in this second case a demodulation signal S equal to zero is obtained, which can thus not be used in order to gather information.

In this second case, the demodulated signal S is given by:

$$\begin{matrix}S = {\int }_{t = 0}^{t = t 1} F ( t ) D cos ( f \cdot 2 π \cdot t + φ ) d t \\ with & ( 22 ) \\ F ( t ) = \{ \begin{matrix}Λ & \vert A cos ( f \cdot 2 π \cdot t ) \vert \leq s \\ 0 & \vert A cos ( f \cdot 2 π \cdot t ) \vert > s\end{matrix} & ( 23 )\end{matrix}$$

Using equation (15), the demodulated signal S can be written as:

$$S = {\sum }_{A cos ( f \cdot 2 π \cdot t ) = 0} Λ \cdot D cos ( f \cdot 2 π \cdot t + φ ) \cdot \vert \frac{s}{Af \cdot 2 π sin ( f \cdot 2 π \cdot t )} \vert \qquad ( 24 )$$

Using equation (17), this becomes:

$$\begin{matrix}S = {\sum }_{k = 0 , 1 , 2 …} Λ \cdot D cos ( \frac{1}{2} π + k \cdot π + φ ) \cdot \vert \frac{s}{Af \cdot 2 π \cdot sin ( \frac{1}{2} π + k \cdot 2 π )} \vert & ( 25 ) \\ S = {\sum }_{k = 0 , 1 , 2 …} \frac{Λ \cdot sD}{Af \cdot 2 π} cos ( \frac{1}{2} π + k \cdot π + φ ) & ( 26 )\end{matrix}$$

From equation (26) it can be seen that the demodulated signal depends on

$$cos ( \frac{1}{2} π + k \cdot π + φ )$$

and the argument of the cosine comprises k.π. Due to this, the cosine will periodically give a positive value, followed by a same but negative value. When summing this, the result will equal zero.

It can thus be concluded that, if the location of the luminescent, e.g. fluorescent, molecule 9 is centred with respect to the modulation of the excitation radiation beam 2, the demodulated signal S will be zero if the frequency of the reference signal R(t) is the same as the modulation frequency f, while a useful result is obtained when the frequency of the reference signal R(t) for demodulation equals twice the modulation frequency.

In another theoretical case, the luminescent, e.g. fluorescent, molecule 9 is not centred with respect to the modulation of the excitation radiation beam 2 and the frequency of the reference signal R(t) is the same as the modulation frequency f. Thus, in this case the luminescent, e.g. fluorescent, molecule 9 is not located at a position x=0 as in the first and second case, but is now assumed to be located at x=x₀, wherein x₀ is different from zero:

$$I ( x ) = \{ \begin{matrix}Λ & \vert x - {x}_{0} \vert \leq s \\ 0 & \vert x - {x}_{0} \vert > s\end{matrix} \qquad ( 27 )$$

The position x of the excitation radiation beam 2 can still be described by means of a periodic function in time t as in equation (2). The luminescence, e.g. fluorescence, signal F(t) can then, in a similar way as in the first and second case, be calculated to be:

$$\begin{matrix}F ( t ) = I ( x ( t ) ) = I ( A cos ( f \cdot 2 π \cdot t ) ) & ( 28 ) \\ F ( t ) = \{ \begin{matrix}Λ & \vert cos ( f \cdot 2 π \cdot t ) - {x}_{0} \vert \leq s \\ 0 & \vert cos ( f \cdot 2 π \cdot t ) - {x}_{0} \vert > s\end{matrix} & ( 29 )\end{matrix}$$

The demodulation signal R(t) has the same frequency as the luminescence, e.g. fluorescence, signal F(t) and thus, in the given case, the demodulation frequency is the same as the modulation frequency f. The demodulated signal S can now be described by:

$$S = {\int }_{t = 0}^{t = t 1} F ( t ) D cos ( f \cdot 2 π \cdot t + φ ) d t \qquad ( 30 )$$

Rewriting this into a sum and using the exposure time as described in equation (15), the integral of equation (30) can be written as:

$$S = {\sum }_{A cos ( f \cdot 2 π \cdot t ) = x 0} Λ \cdot D cos ( f \cdot 2 π \cdot t + φ ) \cdot \vert \frac{s}{Af \cdot 2 π sin ( f \cdot 2 π \cdot t )} \vert \qquad ( 31 )$$

where the sum goes over the values of t where:

$$\begin{matrix}A cos ( f \cdot 2 π \cdot t ) = {x}_{0} & ( 32 a ) \\ f \cdot 2 π \cdot t = k \cdot 2 π \pm arccos ( \frac{{x}_{0}}{A} ) & ( 32 b ) \\ t = \frac{k}{f} \pm \frac{1}{f \cdot 2 π} arccos ( \frac{{x}_{0}}{A} ) & ( 32 c )\end{matrix}$$

This gives:

$$S = {\sum }_{σ = - 1 , + 1 ; k = 0 , 1 , 2 …} Λ \cdot D cos ( σ arccos ( \frac{{x}_{0}}{A} ) + φ ) \cdot \vert \frac{s}{Af \cdot 2 π sin ( σ arccos ( \frac{{x}_{0}}{A} ) )} \vert \qquad ( 33 )$$

Rewriting the cosine and doing the sum over σ:

$$\begin{matrix}S = {\sum }_{k = 0 , 1 , 2 …} Λ \cdot D ( \vert \frac{s}{Af \cdot 2 π} \vert ) \cdot ( \frac{{x}_{0}}{A} ) cos ( - φ ) ( \vert \frac{2}{sin ( arccos ( \frac{{x}_{0}}{A} ) )} \vert ) & ( 34 ) \\ S = {\sum }_{k = 0 , 1 , 2 …} Λ \cdot D \vert \frac{s}{Af \cdot π} \vert \cdot ( \frac{{x}_{0}}{A} ) cos ( - φ ) \frac{1}{\sqrt{1 - {( \frac{{x}_{0}}{A} )}^{2}}} & ( 35 ) \\ S = {\sum }_{k = 0 , 1 , 2 …} Λ \cdot ( \frac{D \cdot {x}_{0} \cdot s}{Af \cdot π} ) \cdot cos ( - φ ) \frac{1}{\sqrt{1 - {( \frac{{x}_{0}}{A} )}^{2}}} & ( 36 )\end{matrix}$$

Equation (36) shows that the demodulated signal S depends on the value of x₀ and on the value of the phase difference between the modulation and reference signal. This effect can be used to find the position of a luminescent, e.g. fluorescent, molecule 9 relative to the position of the excitation radiation beam 2. FIG. 8 shows the demodulated signal S as a function of the position x₀ of the excitation radiation beam 2. For the strongest luminescence signal, the phase difference Φ between the modulation signal and the demodulation signal needs to be set to 0. This can, for example, be done by changing the phase of the reference demodulation signal when the system is not locked onto a luminescent, e.g. fluorescent, molecule 9.

From the above, and as can be seen from FIG. 8, it can be concluded that the demodulated signal S will be positive if x₀ is positive and it will be negative if x₀ is negative. Moreover, the strength of this signal S also increases if the value of x₀ increases, i.e. if the luminescent molecule is further away from the centre of the harmonic movement of the excitation radiation beam. This means that the position of the luminescent, e.g. fluorescent, molecule 9 relative to the excitation radiation beam 2 can be found by determining the sign and strength of the signal S by using a same frequency for the demodulation signal as the frequency imparted to the modulating movement of the excitation radiation beam 2.

In a last theoretical case, the luminescent, e.g. fluorescent, molecule 9 is again not centred with respect to the modulation of the position of the excitation radiation beam 2 (the fluorescent molecule 9 is located at x₀≠0) the and the frequency of reference signal is twice the modulation frequency f. In this case, the demodulation signal S can be calculated in a similar way as in the previous case and becomes:

$$S = {\sum }_{σ = - 1 , + 1 ; k = 0 , 1 , 2 …} Λ \cdot D cos ( σ2arccos ( \frac{{x}_{0}}{A} ) + φ ) \cdot \vert \frac{s}{Af \cdot 2 π sin ( σ arccos ( \frac{{x}_{0}}{A} ) )} \vert \qquad ( 37 )$$

When making the sum over σ and rewriting the cosine, this gives:

$$\begin{matrix}S = {\sum }_{k = 0 , 1 , 2 …} Λ \cdot D \frac{s}{Af \cdot 2 π} \cdot cos ( - φ ) \cdot ( 2 {cos}^{2} ( arccos ( \frac{{x}_{0}}{A} ) ) - 1 ) \vert \frac{2}{sin ( arc cis ( \frac{{x}_{0}}{A} ) )} \vert & ( 38 ) \\ S = {\sum }_{k = 0 , 1 , 2 …} Λ \cdot D \frac{s}{Af \cdot 2 π} \cdot cos ( - φ ) \cdot ( 2 {( \frac{{x}_{0}}{A} )}^{2} - 1 ) \vert \frac{2}{\sqrt{1 - {( \frac{{x}_{0}}{A} )}^{2}}} \vert & ( 39 ) \\ S = {\sum }_{k = 0 , 1 , 2 …} Λ \cdot D \frac{s cos ( - φ )}{Af \cdot π} \cdot \frac{2 {( \frac{{x}_{0}}{A} )}^{2} - 1}{\sqrt{1 - {( \frac{{x}_{0}}{A} )}^{2}}} & ( 40 )\end{matrix}$$

From equation (40) it can be concluded that for a demodulation frequency of twice the modulation frequency, the demodulated signal S only depends on the phase Φ and on the value of x₀, but not on the sign of x₀. This is also illustrated in FIG. 9 where the demodulated signal S is shown as a function of the position x₀ of the excitation radiation beam 2. From this figure it can also be seen that the intensity of the signal is the highest at x₀=0. Therefore, using a demodulation frequency which equals twice the modulation frequency can also be used to find the exact location of the luminescent molecule, albeit less good than when a demodulation frequency equal to the modulation frequency is used, because it is slower. However, for the determination of the location as described above phase information of the signal is required. This requires the phase to be calibrated first, which leads to a more complex method. Therefore, this method is not the preferred way to find the location of the luminescent, e.g. fluorescent, molecule 9. It is, however, a preferred method for measuring the luminescence, e.g. fluorescence, value because it is known from FIG. 9 that the highest value of the luminescence, e.g. fluorescence, can be measured at x₀=0 if the demodulation frequency is twice the modulation frequency.

From the above discussion it can be seen that, depending on the application, the modulation of the excitation radiation beam 2 can be adapted in order to obtain the right information. Furthermore, it becomes clear that the frequency of the demodulation signal and the position of the excitation radiation beam 2 with respect to the luminescent, e.g. fluorescent, molecules 9 should be chosen as a function of the application.

Hereinafter, some specific embodiments according to the invention will be described.

As already discussed before, the background noise in the luminescence signal 7, e.g. fluorescence signal, depends on the total area that is illuminated because the excitation radiation beam 2 not only illuminates the luminescent, e.g. fluorescent, molecule 9 but also illuminates its environment, e.g. the medium the luminescent molecules 9 are present in. This environment causes background signals or noise, which can be reduced by using an excitation radiation beam 2 of which the projection onto a target or spot, e.g. onto the sample plate 3 is small with respect to the size of luminescent, e.g. fluorescent, molecules 9 to be detected. This may done by, for example, using an excitation radiation beam 2 having a diffraction limited projection or spot, i.e. a spot having sizes equal to the diffraction limit of the medium the luminescent, e.g. fluorescent, molecules 9 are present in.

FIG. 10 shows how an excitation radiation beam 2 with a small excitation spot is able to improve the signal-to-noise level. Unfortunately, the problem is that it takes a lot more time to measure a large area with such a small diffraction limited excitation spot. The figure illustrates what happens in different situations.

In a first situation, only a constant normal background signal is present (indicated by reference number 20), e.g. from the solution the luminescent, e.g. fluorescent, molecules 9 are present in, but no luminescent, e.g. fluorescent, molecule 9 is hit by the large excitation radiation beam 2 (indicated by the large circle 21a). Because the background signal is constant, the modulation scheme according to this first situation will completely remove this background signal and thus no luminescence, e.g. fluorescence, signal 7 is detected.

In a second case (indicated by reference number 30), parasitic luminescent, e.g. fluorescent, molecules are present. In this case, a false positive is detected with a large excitation radiation beam 2 (indicated by large circle 31a). However, when the size of the excitation radiation beam 2 is reduced (smaller circle indicated by 31b) the excitation radiation beam 2 only hits one parasitic luminescent, e.g. fluorescent, molecule, giving a low luminescence, e.g. fluorescence, signal and eventually, no positive detection signal is given. Alternatively, for other parasitic luminophores, e.g. fluorophores, the luminescence, e.g. fluorescence, signal 7 may be much higher than is expected for a true luminophore 9. Also in such cases, the positive detection signal may be rejected. For this second case (indicated by reference number 30), the rejection of signals may, for example, be done by comparing the detected signal with an expected signal, the expected signal being determined in beforehand for a certain spot size of the excitation radiation beam 2.

In another case (indicated by reference number 40), a true luminescent, e.g. fluorescent, molecule 9 is present. The luminescent, e.g. fluorescent, molecule 9 is hit by the large excitation radiation beam (indicated by large circle 41a). When the size of the excitation radiation beam 2 is reduced (indicated by smaller circle 41b) the true luminescent, e.g. fluorescent, molecule 9 is still hit and a luminescence, e.g. fluorescence, signal is detected.

In a last case, an area is present with locally increased background signal (indicated by reference number 50). The larger excitation radiation beam (indicated by large circle 51a) detects a high background signal and gives a false positive. When the size of the excitation radiation beam 2 is reduced (indicated by smaller circle 51b), only a small background signal is detected. Eventually, no positive detection signal is given.

Therefore, according to a first specific embodiment of the invention, the background signal of a luminescence, e.g. fluorescence, signal 7 is reduced or the SNR is improved by first searching for luminescence, e.g. fluorescence, radiation 7 with an excitation radiation beam 2 having a large projection onto a target or excitation spot by modulating the position of the excitation radiation beam 2. Thereafter, when a luminescence, e.g. fluorescence, molecule 9 (false-positive or not) is detected, reducing the size of the excitation spot, and hence, noise in the detection signal as well, in order to check whether the detection signal was a false-positive or not. By minimising signals coming from false-positives, the accuracy of the method and device according to the present invention may be improved.

Searching for or locating of luminescent, e.g. fluorescent, molecules 9 can be performed by the method as described above in the third theoretic case. An excitation radiation beam 2 is modulated with a modulation signal having a frequency f. In order to be able to locate luminescent molecules 9 with respect to the excitation radiation beam 2 the frequency of the reference signal should be the frequency as the modulation frequency f. By scanning the sample plate 3 with a modulated excitation radiation beam 2b as discussed above, a graph can be obtained as in FIG. 8. From this graph, the relative position of luminescent molecules 9 with respect to the excitation radiation beam 2 can be determined.

According to this embodiment of the present invention, when the excitation radiation beam 2 of a luminescent sensor, e.g. a luminescent biosensor or a luminescent chemical sensor, is spatially modulated, the excitation radiation beam 2 will periodically move over the sample plate 3 comprising luminescent molecules 9. Due to this, the luminescence signal 7 as a response to the modulated excitation radiation beam 2b will periodically appear and disappear. As already discussed the demodulated signal also depends on the position of the luminescent molecule 9 relative to the central position of the modulation. Hereinafter, the relation between the demodulated signal and the position of the excitation radiation beam 2 will be demonstrated.

Hereinafter, again the different situations of the position of the luminescent, e.g. fluorescent, molecules 9 with respect to the modulation of the excitation radiation beam 2 will be described, for the ease of understanding only. FIG. 11 illustrates the situation where the luminescent, e.g. fluorescent, molecule 9 is positioned at the left of the centre of the modulation movement. The lower part of FIG. 11 shows what happens with the luminescence signal (dotted line) and the reference signal for demodulation (dashed line) during one period of scanning beam (i.e. e.g. scanning beam moving from left to right and back). In this case, the luminescence, e.g. fluorescence, signal 7, indicated by the dotted line in the lower part of FIG. 11, starts high when the location of the excitation radiation beam 2, indicated by the full black arrow, is such that it illuminates the luminescent molecule 9, and goes to zero as the excitation radiation beam 2 moves away in a direction indicated by arrow 6 and by the dotted black arrows. When the excitation radiation beam 2 moves back, the luminescence, e.g. fluorescence, signal 7 becomes higher again. In the case illustrated in FIG. 11, the luminescence, e.g. fluorescence, signal 7 (dotted line) is out of phase with the reference signal for demodulation (indicated by the dashed line in the lower part of FIG. 11). This means that the demodulated signal will be negative (see FIG. 8), corresponding with the luminescent molecule being located at the left hand side of the centre position of the modulation movement.

FIG. 12 illustrates the situation where a luminescent, e.g. fluorescent, molecule 9 is located in the centre of the modulation of the excitation radiation beam 2. The lower part of FIG. 12 shows what happens with luminescence signal and reference signal for demodulation during one period of the scanning beam. The luminescence, e.g. fluorescence, signal 7, indicated by the dotted line in the lower part of FIG. 12, goes high and low twice, during one oscillation of the modulated excitation radiation beam 2b, i.e. goes high every time the scanning beam passes through the centre of the modulation movement where the luminescent molecule is located. The reference signal for demodulation is shown by the dashed line in the lower part of FIG. 12. Due to the reference signal for demodulation having the same frequency as the modulation signal, a demodulated signal of zero is obtained, indicating that the luminescent molecule is positioned at the centre of the modulation movement.

FIG. 13 illustrates the situation where a luminescent, e.g. fluorescent, molecule 9 is positioned at the right of the centre of the modulation of the excitation radiation beam 2. The lower part of FIG. 13 shows what happens with the luminescence signal (dotted line) and the reference signal for demodulation (dashed line) during one period of scanning beam (i.e. e.g. scanning beam moving from left to right and back). In this case, the luminescence, e.g. fluorescence, signal 7 (dotted line in the lower part of FIG. 13) now shows the inverse behaviour with respect to the situation illustrated in FIG. 11, i.e. the situation where the luminescent molecule 9 is positioned at the left of the centre of the modulation of the excitation radiation beam 2. This means that the luminescence, e.g. fluorescence, signal 7 is in phase with the reference signal for demodulation, giving a positive demodulated signal (see FIG. 8), corresponding with the luminescent molecule being located at the left hand side of the centre position of the modulation movement.

Using the information of the demodulated luminescence, e.g. fluorescence, signal it is thus possible to position the excitation radiation beam exactly centred onto the luminescent, e.g. fluorescent, molecule 9 because the demodulated signal gives information about the location of this luminescent, e.g. fluorescent, molecule 9.

Once the luminescent, e.g. fluorescent, molecule 9 is located, the excitation radiation beam 2 is located and modulated such that the luminescent, e.g. fluorescent, molecule 9 is centred with respect to the excitation radiation beam 2 while the spot size of the excitation radiation beam 2 is reduced. For example, the size of the projection of the excitation radiation beam 2 or the spot size can be decreased down to a diffraction-limited spot, i.e. to a spot with sizes equal to the diffraction limit of the medium the luminescent, e.g. fluorescent, molecule 9 is present in.

The luminescent, e.g. fluorescent, molecule 9 is irradiated with an excitation radiation beam having a modulation frequency f. Measuring the luminescence, e.g. fluorescence, radiation 7 and demodulating the detected signal with a demodulation signal having a frequency which equals twice the modulation frequency f leads to a luminescence, e.g. fluorescence, signal with an improved signal-to-noise ratio as discussed for the first theoretical case. If the luminescence, e.g. fluorescence, signal is still high enough, the hereinabove detected signal is a true-positive and otherwise, the hereinabove detected signal was a false-positive.

Summarised, the method according to the first specific embodiment of the invention can comprise the following subsequent steps:

1) Start looking for a positive luminescence, e.g. fluorescence, signal 7 by scanning the sample plate 3 with an excitation radiation beam 2 having a first size, for example a relatively large excitation spot.
2) When a positive luminescence, e.g. fluorescence, signal is found, use modulation of the excitation spot in accordance with the present invention in order to find the exact position of the luminescent, e.g. fluorescent, molecule 9, which is the source of the luminescence, e.g. fluorescence, radiation 7, relative to the excitation radiation beam 2. The sign and amplitude of the demodulated signal is used as error signal to find the position of the luminescent molecule 9.
3) Use the information gained in 2) as reference to centre the position of the excitation radiation beam 2 with respect to the luminescent, e.g. fluorescent, molecule 9.
4) While repeating steps 2) and 3), shrink the size of the excitation spot.
5) Re-measure the luminescence, e.g. fluorescence, signal and determine whether or not there was a false-positive.
6) Continue at 1) to look for the presence of a next luminescent molecule 9.

The method according to this first specific embodiment allows determination of whether a detected luminescent, e.g. fluorescent, molecule 9 is a false-positive or not, while still using a larger excitation spot when searching for luminescent, e.g. fluorescent, molecules 9. The method according to the first specific embodiment of the invention thus makes it possible to scan a target with a relatively large excitation radiation beam 2 and then to zoom in on a potential positive signal, using modulation to keep the excitation beam centred.

As already discussed, a way to reduce the background signal is to use an excitation radiation beam 2 with a diffraction-limited projection or a diffraction-limited spot size, i.e. an excitation radiation beam 2 of which the projection or spot onto a target, e.g. the sample plate 3, has sizes equal to the diffraction limit of the medium the luminescent, e.g. fluorescent, molecules 9 are present in. However, a background signal still remains for luminescent, e.g. fluorescent, molecules 9 with a size smaller than the diffraction limited excitation radiation beam 2 or spot.

A challenge/problem is to increase the signal-to-noise ration (SNR) beyond the limit set by the diffraction limit. In addition, it is desired to further increase the SNR of the measured luminescence, e.g. fluorescence, signal.

Therefore, in this second specific embodiment according to the present invention, the excitation radiation beam 2 is modulated by harmonically moving the excitation radiation beam 2 over the luminescent, e.g. fluorescent, molecule 9. Through this, the luminescence radiation 7, e.g. fluorescence radiation, generated by the luminescent, e.g. fluorescent, molecules 9 becomes a harmonic signal with modulation frequency AcO while the background signal remains unchanged. Using an inverse Fourier analysis, the luminescence, e.g. fluorescence, signal 7 can be separated from the background, due to the difference in modulation frequency between the luminescence, e.g. fluorescence, signal and the background signal.

In this embodiment, the position of the excitation radiation beam 2 is modulated, moving the excitation radiation beam 2 over the luminescent, e.g. fluorescent, molecule 9 and back. This is schematically illustrated in FIGS. 11-13. This modulation in the position of the excitation radiation beam 2 is added on top of the normal scanning movement of the excitation radiation beam 2, as already discussed before, and is a fast but small position oscillation. With a fast modulation speed is meant that the modulation will have a frequency at least in the order of kHz, i.e. 1 kHz or above but preferably in the order of MHz, i.e. 1 MHz or above. With small oscillation is meant an oscillation that has an amplitude that is typically larger than the size 2s of the luminescent, e.g fluorescent, molecule 9, and smaller than a few times this length. Typically, this amplitude may be in the order of less than 1 micrometer. It is not anticipated that an upper limit for the amplitude is a limitation of the present invention. However, a practical problem that can arise with an oscillation having a large amplitude is that the modulation frequency that can be used may become smaller because it is easier to reach a high frequency when the oscillation has a smaller amplitude.

The frequency of the scanning movement, i.e. the movement referred to in this document as the first movement in a first direction 5, depends on the application, but it should preferably not be greater than the frequency of the modulation, i.e. the second movement in a second direction 6, and it should preferably be at least a factor 10 below the frequency of the modulation.

According to this second specific embodiment of the invention, modulation of the position of the excitation radiation beam 2 can be achieved in several ways, for example, by changing the focal plane of the input beam of a multi-mode interferometer (MMI) or by using an acousto-optic modulator (AOM), a prisma-pair, a mirror that is moved with a galvano or a piezo, or by using a liquid crystal.

Depending on whether or not a luminescent, e.g. fluorescent, molecule 9 is illuminated with the excitation radiation beam 2, and thus depending on the relative position of the excitation radiation beam 2 with respect to the luminescent molecules 9 the luminescence signal 7 will repeatedly turn on and off due to the harmonic movement imparted to the excitation radiation beam 2. As a result, the luminescence signal 7 is modulated with the same frequency as the excitation radiation beam 2. The frequency of the reference signal for demodulation should be twice the modulation frequency, in order to at least partially remove the background signal and thus to improve the SNR of the luminescence signal.

The modulated luminescence, e.g. fluorescence, signal 7 is then measured by means of a detector 8 (see FIG. 1). The detector 8 may be any suitable detector 8, e.g. a charge coupled device (CCD) or complementary metal oxide semiconductor (CMOS) detector.

The measured signal is then demodulated using electronics such as e.g. a lock-in amplifier, and the resulting signal gives the background-free luminescence, e.g. fluorescence, signal, hence resulting in a signal with improved signal-to-noise ratio.

Because electric noise scales with the inverse of the frequency of the modulation or with 1/f, there is also a noise improvement here, yielding a further improvement of the SNR. 1/f noise is a type of noise that occurs very often in processes found in nature. When using this technique most noise can be removed, but 1/f noise still remains. The intensity of this type of noise goes down with increasing frequency. A preferred requirement for this detection scheme is that the response time of the luminescent, e.g. fluorescent, molecules 9 is shorter than the modulation frequency of the excitation radiation beam 2. For a luminescent, e.g. fluorescent, molecule 9 with a luminescence, e.g. fluorescence, lifetime in the order of ms, this implies a maximum modulation frequency of about 100 Hz. This implies that the improvement of the SNR due to e.g. 1/f noise is somewhat limited in this case. However, many luminescent, e.g. fluorescent, molecules 9 have a luminescence lifetime τₗᵤₘ, e.g. fluorescence lifetime τ_{fluor}, in the order of a few nanoseconds enabling modulation frequencies in the MHz regime. A few examples of fluorescence molecules and their lifetimes are:

1. e.g. Cyanine, Alexa, fluoresceine: τ_{fluor}˜1-5 ns
2. e.g. Ru, Ir: τ_{fluor}˜1 μs
3. e.g. Eu, Tb: τ_{fluor}˜1 ms

It has to be noted that even though the above discussion is held for only one excitation radiation beam, the invention may also be applied to multiple excitation radiation beams. In that case, according to an embodiment of the invention, the sensor may comprise multiple excitation radiation sources 1, e.g. light sources, and the same number of detectors 8. The advantage of this is that finding luminescent, e.g. fluorescent, molecules 9 can be done faster, because multiple sites are probed at the same time. When a luminescent, e.g. fluorescent, molecule 9 is found, the modulation method is used only for one excitation radiation source 1, e.g. light source, and sensor pair, after which searching is restarted with all spots coming from the multiple excitation radiation sources 1, e.g. light sources.

It is to be understood that although preferred embodiments, specific constructions and configurations, as well as materials, have been discussed herein for devices according to the present invention, various changes or modifications in form and detail may be made without departing from the scope and spirit of this invention.

1. Method for the detection of an optically variable molecule (9) in or on a sample (3), the method comprising:
moving the sample relative to an excitation radiation beam (2) in a first direction, hereby exciting said optically variable molecule (9) and thus generating a luminescence signal (7), and
detecting said generated luminescence signal (7),
wherein the method furthermore comprises spatially modulating the relative position of the excitation radiation beam (2) with respect to the sample when detecting the luminescence signal (7), said modulation including relative movement of the excitation radiation beam with reference to the sample in a second direction different from said first direction.

2. Method according to claim 1, furthermore comprising demodulating said detected luminescence signal (7), thus generating a demodulated signal.

3. Method according to claim 2, further comprising using sign and/or amplitude of the demodulated signal as an error signal for the position of the optically variable molecule (9).

4. Method according to claim 2, said modulation being performed with a first frequency and a demodulation signal for demodulating having a second frequency, wherein the second frequency is twice the first frequency.

5. Method according to claim 2, said modulation being performed with a first frequency and a demodulation signal for demodulating having a second frequency, wherein the second frequency is the same as the first frequency.

6. Method according to claim 5, the excitation radiation beam having a spot with a size, the method furthermore comprising:
from said detected luminescence signal (7) determining a relative position of said optically variable molecule (7) with respect to said excitation radiation beam (2),
centring said excitation radiation beam (2) with respect to said optically variable molecule (9),
reducing the size of said spot, and
determining a further generated luminescence signal.

7. Method according to claim 6, furthermore comprising using the further generated luminescence signal for determining whether the generated luminescence signal (7) indicated a false positive or not.

8. Method according to claim 1, wherein the excitation radiation beam (2) is a single excitation radiation beam (2).

9. A sensor for detecting an optically variable molecule (9) in or on a sample (3), the sensor comprising:
an excitation radiation source (1) for generating an excitation radiation beam (2),
scanning means for moving the excitation radiation beam (2) relative to the sample in a first direction for scanning the sample (3),
wherein the sensor furthermore comprises modulating means (4) for spatially modulating the relative position of the excitation radiation beam (2) with respect to the sample to provide relative movement of the excitation radiation beam with respect to the sample in a second direction different from said first direction.

10. A sensor according to claim 9, said luminescent molecule (9) generating a luminescence signal (7) upon irradiation with said excitation radiation beam (2), the sensor furthermore comprising a detector (6) for detecting said generated luminescence signal (7).

11. A sensor according to claim 10, wherein said detector (6) is one of a charge coupled device or complementary metal oxide semiconductor detector.

12. A sensor according to claim 10, furthermore comprising demodulating means (4) for demodulating said detected luminescence signal (7).

13. A sensor according to claim 12, wherein said demodulating means (4) is a lock-in amplifier.

14. A sensor according to claim 9, wherein the excitation radiation beam (2) is a single excitation radiation beam (2).
